(19) United States
(12) Patent Application Publication
(10) Pub. No.: US 2015/0171777 A1
(43) Pub. Date: Jun. 18, 2015

(54) METHOD FOR CONTROLLING DRIVING MOTOR

(71) Applicant: Hyundai Motor Company, Seoul (KR)

(72) Inventor: Soon Woo KWON, Gyeonggi-do (KR)

(73) Assignee: Hyundai Motor Company, Seoul (KR)

(21) Appl. No.: 14/268,595

(22) Filed: May 2, 2014

(30) Foreign Application Priority Data
Dec. 18, 2013 (KR) 10-2013-0157736

(51) Int. Cl. H02P 6/00

(52) U.S. Cl. CPC H02P 6/002

(57) ABSTRACT

A method for controlling a driving motor method includes comparing revolutions per minute of the driving motor with a magnitude of a medium and high speed reference speed. A current and a voltage applied to the driving motor are calculated to thereby calculate an input power when the revolutions per minute of the driving motor is larger than the medium and high speed reference speed. A q-axis current instruction is adjusted based on whether or not the calculated input power is in a zero-torque determination reference power range.

### CROSS REFERENCE TO RELATED APPLICATION

The present application claims the benefit of priority to Korean Patent Application Number 10-2013-0157736 filed on Dec. 18, 2013, the entire contents of which is incorporated herein for all purposes by this reference.

### TECHNICAL FIELD

The present disclosure relates to a method for controlling a driving motor, and more particularly, to a method for controlling a driving motor capable of accurately controlling zero torque upon using the driving motor having a permanent magnet.

### BACKGROUND

A fuel cell and hybrid vehicle can be driven using an electric vehicle (EV) driving mode by a driving motor converting electrical energy from a high voltage battery to mechanical energy. In addition, the mechanical energy upon rotation of an engine and a wheel is conversely collected by the driving motor and is converted into the electrical energy by an inverter, thereby charging the battery. This regenerative braking allows the electrical energy generated by backward driving the motor upon vehicle braking to be charged into the battery by the inverter.

When the driving motor (interior permanent magnet synchronous motor) for the fuel cell and/or a hybrid vehicle is used, it is difficult to control zero-torque at medium and high speeds. FIGS. 1 and 2 are graphs showing a current instruction map for controlling zero-torque and a variant of torque according to revolutions per minute of the motor when the permanent magnet motor according to the related art is used. FIG. 1 shows current instruction values at low, medium, and high speeds for controlling the zero-torque, and FIG. 2 shows that a slight regenerative braking may be caused by manufacturing deviation at the time of assembling the motor and a resolver, which is a position sensor, even though a negative increase of torque should not be theoretically present.

When constructing a current map according to the related art, the current map has been compensated offline. In this case, if a state of charge (SOC) of a high voltage battery is high, the battery may not be charged by the regenerative braking. If the regenerative braking is generated despite a control of zero-torque, a voltage of a direct current terminal may be increased, thereby shutting down high voltage components.

### SUMMARY

An aspect of the present disclosure provides a method for controlling a driving motor capable of more accurately controlling zero-torque using a relationship between input and output power of the motor.

According to an exemplary embodiment of the present disclosure, a method for controlling a driving motor includes comparing revolutions per minute of the driving motor with a magnitude of a medium and high speed reference speed. A current and a voltage applied to the driving motor are calculated to determine an input power when the revolutions per minute of the driving motor is larger than the medium and high speed reference speed A q-axis current instruction is adjusted based on whether or not the calculated input power is in a zero-torque determination reference power range.

The step of adjusting the q-axis current instruction may include increasing the q-axis current instruction when the input power is smaller than a lower limit of the zero-torque determination reference power range.

The step of adjusting the q-axis current instruction may include decreasing the q-axis current instruction when the input power is larger than an upper limit of the zero-torque determination reference power range.

The zero-torque determination reference power range may be determined according to the revolutions per minute of the driving motor and torque in a torque range having a predetermined margin from zero-torque.

A current revolutions per minute of the driving motor may be detected by a speed detector.

The motor driving current is detected by the current detector thereby to send to a motor controller (MC).

The step of comparing the revolutions of minute of the driving motor is performed by a motor controller.

The q-axis current instruction, which is transmitted to a current controller, and a q-axis detection current are compared by the current controller thereby to generate a q-axis voltage instruction.

The MC performs an axis transformation from a voltage instruction of a synchronous frame to a voltage instruction of a stationary frame.

An inverter supplies a three-phase alternating current power as a driving power of the driving motor.

### BRIEF DESCRIPTION OF THE DRAWINGS

FIG. 1 shows a current instruction map used for a zero-torque control according to the related art.

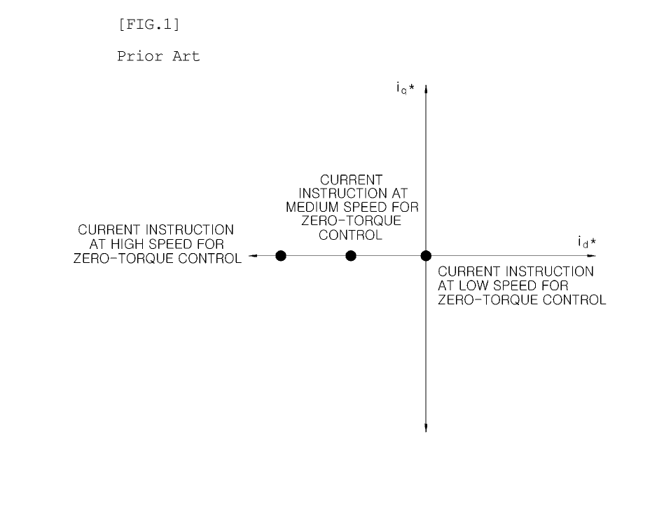

FIG. 2 is a graph showing torques generated due to manufacturing deviation when a resolver is assembled in a driving motor according to the related art.

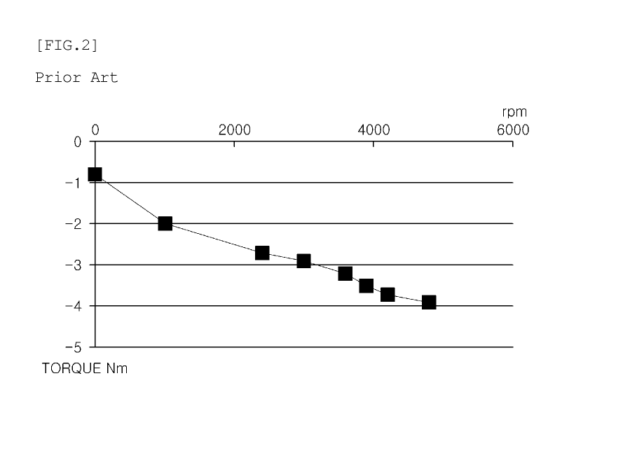

FIG. 3 is a flow chart showing a method for controlling a driving motor according to an exemplary embodiment of the present disclosure.

FIG. 4 is a block diagram showing a system for controlling a driving motor according to an exemplary embodiment of the present disclosure.

### DETAILED DESCRIPTION

Specific descriptions on structure and function of embodiments of the present disclosure described herein are merely illustrative and not construed to limit the disclosure thereto.

Since the present disclosure may be variously modified and have several exemplary embodiments, specific exemplary embodiments will be shown in the accompanying drawings and be described in detail. However, it is to be understood that the present disclosure is not limited to the specific exemplary embodiments, but includes all modifications, equivalents, and substitutions included in the spirit and the scope of the present disclosure.

Terms such as ‘first’, ‘second’, etc., may be used to describe various components, but the components are not to be construed as being limited to the terms. The terms are used only to distinguish one component from another component. For example, the ‘first’ component may be named the ‘second’ component and the ‘second’ component may also be similarly named the ‘first’ component, without departing from the scope of the present disclosure.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Other expressions describing a relationship between components, that is, “between,” “directly between,” “neighboring to,” “directly neighboring to” and the like, should be similarly interpreted.

Terms used in the present specification are used only in order to describe specific exemplary embodiments rather than limiting the present disclosure. Singular forms used herein are intended to include plural forms unless explicitly indicated otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those who skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present disclosure will be described in detail with reference to the accompanying drawings. Like reference numerals denote like components throughout the drawings.

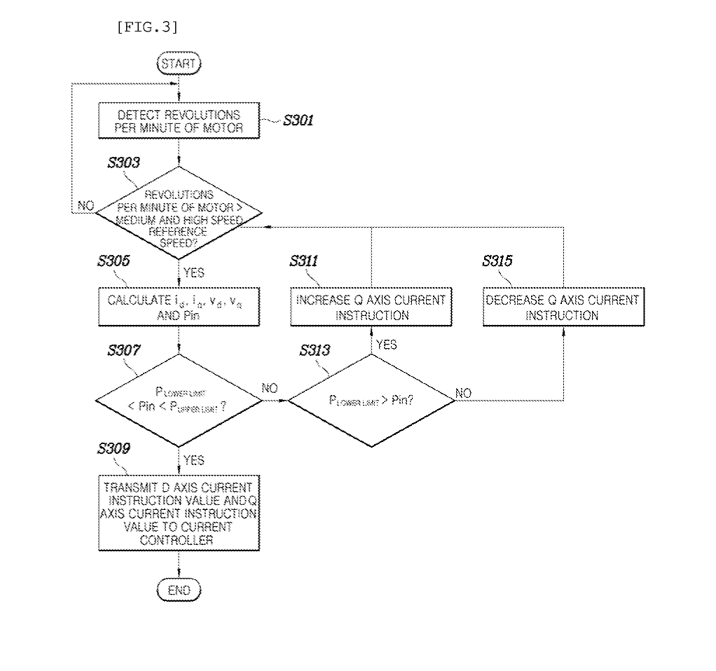

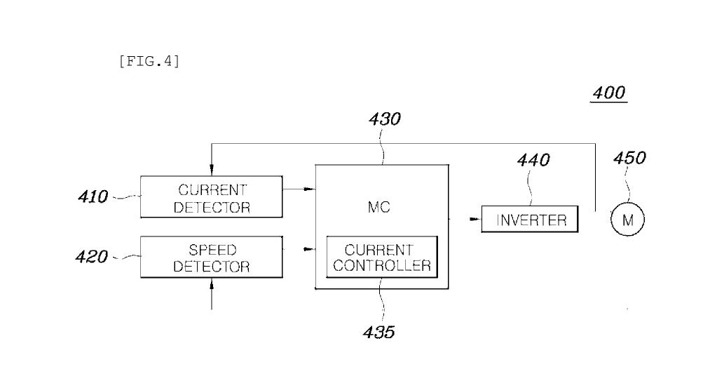

FIG. 3 is a flow chart showing a method for controlling a driving motor according to an exemplary embodiment of the present disclosure. FIG. 4 is a block diagram showing a system for controlling a driving motor according to an exemplary embodiment of the present disclosure. Referring to FIGS. 3 and 4, a system 400 for controlling a driving motor may include a driving motor 450 driven by electric power, an inverter 440 supplying three-phase alternating current power as driving power of the driving motor 450, a motor controller (MC) 430 controlling the inverter 440 with a pulse width modulation (PWM) scheme to drive phase transformation, a speed detector 420 detecting a revolutions per minute of the driving motor 450, and a current detector 410 detecting a current applied to the driving motor 450.

For reference, an overall operation of a fuel cell vehicle is controlled by a fuel cell controller (FC), wherein the FC may communicate with the MC 430, which is a sub-controller, to control torque, speed, and an electricity generation torque amount of the driving motor 450. The FC may communicate with an engine control unit (ECU) which controls an engine for generating a voltage as an assist power source to perform a relay control and fault diagnosis related to an engine start.

The speed detector 420 may detect a current revolutions per minute of the driving motor 450 (S301). The MC 430 compares the detected revolutions per minute with a preset medium and high speed reference speed (S303). The MC 430 may compare a magnitude of the revolutions per minute of the driving motor 450 with a magnitude of the medium and high speed reference speed and may calculate current (i_{d} and i_{q}) and voltage (v_{d} and v_{q}) applied to the driving motor 450 to thereby calculate an input power Pin (S305) when the revolutions per minute of the driving motor 450 is larger than the medium and high speed reference speed.

The current detector 410 may be connected between the inverter 440 and the driving motor 450 to thereby detect a motor driving current of each phase. The current detector 410 may be a current transducer continuously detecting the motor driving current. The current transducer detects the motor driving current, converts the detected motor driving current into a voltage signal and outputs it to the MC 430. For example, in a case of a three-phase driving motor, the current detector 410 detects all currents (iₐ, i_{b}, and i_{c}) applied to the three-phase or detects only the current (iₐ and i_{b}) of a two-phase among these to thereby calculate i_{c}, and may then output it to MC 430. This current is coordinate-converted to thereby generate a d-axis current instruction i*_{d} and a q-axis current instruction i*_{q}.

The MC 430 may adjust the q-axis current instruction (S311, S315) based on whether or not the calculated input power Pin is in a zero-torque determination reference power range (P_{lower limit} to P_{upper limit}) (S307, S313).

When the revolutions per minute of the driving motor 450 is classified into three steps of a low speed, a medium speed, and a high speed, the medium and high speed reference speed means a speed that the revolutions per minute of the driving motor 450 corresponds to a medium and the high speed region rather than a low speed range. That is, in the case in which the revolutions per minute of the driving motor 450 is higher than the medium and high speed reference speed, torque precision of the driving motor 450 is decreased. In the case in which the driving motor 450 rotates at high speed, since the revolutions per minute is large, a power change is significantly generated even in a case a small torque change. That is, the medium and high speed region particularly requires the zero-torque control. Therefore, in the case in which the current revolutions per minute of the driving motor 450 is larger than the medium and high speed reference speed, the MC 430 performs the zero-torque control and increases or decrease the q-axis current instruction i*_{q} to perform the zero-torque control (S311, S315).

In the case in which the input power Pin is smaller than a lower limit of the zero-torque determination reference power range (S313), the MC 430 may determine that the driving motor is regenerative braked to thereby increase the q-axis current instruction (S311). In the case in which the input power Pin is not in the zero-torque determination reference power range and is not smaller than the lower limit of the zero-torque determination reference power range, that is, the input power Pin is larger than an upper limit of the zero-torque determination reference power range (S313), the MC 430 may determine that the driving motor decreases the q-axis current instruction (S315).

In the case in which the input power Pin is in the zero-torque determination reference power range, since the currently generated input power is adjacent the zero-torque, it is not necessary to change the q-axis current instruction. That is, both the d-axis current instruction and the q-axis current instruction may be output to the current controller 435.

The MC 430 may include the current controller 435 generating voltage instructions based on current instructions. The current controller 435 receives the q-axis current instruction i*_{q} and the d-axis current instruction and outputs the voltage instructions (S309). The current controller 435 generates a q-axis voltage instruction V*_{q} by transmitting the q-axis current instruction through a proportional integral controller and a filter. The current controller 435 compares the q-axis current instruction and a q-axis detection current i_{q}, which is obtained by performing an axis transformation of the motor driving current to each other. The current controller 435 then generates the q-axis voltage instruction V*_{q} by transmitting an error between the q-axis current instruction and the q-axis detection current through the proportional integral controller and the filter. The current controller 435 generates a d-axis voltage instruction V*_{d} by passing the d-axis current instruction through the proportional integral controller and the filter. The current controller 435 compares the d-axis current instruction and a d-axis detection current i_{d}, which is obtained by performing an axis transformation of the motor driving current to each other The current controller 435 then generates the d-axis voltage instruction V*_{d} by transmitting an error between the d-axis current instruction and the d-axis detection current through the proportional integral controller and the filter.

The MC 430 may generate a control signal according to the voltage instruction and may output the control signal to the inverter 440. That is, the MC 430 performs the axis transformation from a voltage instruction of a synchronous frame to a voltage instruction of a stationary frame. For example, (V*_{d}, V*_{q}) is transformed to (V*ₐ, V*_{b})

Since it is impossible to control torque to substantially become perfect zero-torque, the zero-torque determination reference power range means a range in which a power generated by the regenerative braking or motoring is small which may be considered as the zero-torque control. That is, the zero-torque determination reference power range means a power range determined by the revolutions per minute of the driving motor 450 and torque in a torque range having a predetermine margin from zero-torque. The power, which is substantially generated, is a product of the revolutions per minute of the driving motor 450 and torque. In the case in which torque has a negative value, power according to the regenerative braking is generated, and in the case in which torque has a positive value, power by the motoring is generated.

In the case in which the zero-torque control is not performed in the medium and high speed region, power due to the regenerative braking is generated, and this power needs to be charged into the high voltage battery. However, in the case in which it is impossible to charge the high voltage battery due to a high SOC of the high voltage battery, since the entire system may be shut down, the zero-torque control is required.

When a driver manipulates an acceleration pedal or manipulates a brake pedal, a signal according to the manipulation may be transmitted to a vehicle controller, and the vehicle controller may transmit a driving or braking torque instruction signal of the driving motor 450 to the MC 430. The MC 430 issues the current instruction according to the torque instruction signal. The controlled current is supplied to the driving motor 450, and torque corresponding to the controlled current is generated.

Specifically, when the input power is smaller than the lower limit of the zero-torque determination reference power range, the MC 430 may increase the q-axis current instruction, and when the input power is larger than the upper limit of the zero-torque determination reference power range, the MC 430 may decrease the q-axis current instruction.

The inverter 440 applies a three-phase alternating current to the driving motor 450. The inverter 440 controls a voltage (inverter output voltage) by a pulse width modulation (PWM) scheme in order to control the three-phase current (iᵤₛ, iᵥₛ, i_{ws}) applied to the driving motor 450 and includes a power module (not shown) configured by a fast switchable semiconductor switch (e.g., IGBT) and a current loop diode upon electricity generated. The PWM control scheme is a scheme controlling the voltage (or current) by changing a width of a switching pulse for switching the semiconductor switch in the inverter. A triangular wave comparison PWM scheme and a spatial vector PWM scheme are widely used. Since a pulse width modulation and a three-phase current control of the inverter 440 are well known technologies in the art, a detailed description thereof will be omitted.

According to the exemplary embodiment of the present disclosure, the method for controlling the driving motor may perform the zero-torque control despite a manufacturing deviation of the motor to thereby prevent the system from being shut down, and a power distribution may be more precisely controlled.

Although the embodiments of the present disclosure have been described in detail, they are only examples. It will be appreciated by those skilled in the art that various modifications and equivalent other embodiments are possible from the present disclosure. Accordingly, the actual technical protection scope of the present disclosure must be determined by the spirit of the appended claims.

What is claimed is:

1. A method for controlling a driving motor, the method comprising:
comparing revolutions per minute of the driving motor with a magnitude of a medium and high speed reference speed;
calculating a current and a voltage applied to the driving motor to thereby calculate an input power when the revolutions per minute of the driving motor is larger than the medium and high speed reference speed; and
adjusting a q-axis current instruction based on whether or not the calculated input power is in a zero-torque determination reference power range.

2. The method of claim 1, wherein the step of adjusting the q-axis current instruction includes increasing the q-axis current instruction when the input power is smaller than a lower limit of the zero-torque determination reference power range.

3. The method of claim 1, wherein the step of adjusting the q-axis current instruction includes decreasing the q-axis current instruction when the input power is larger than an upper limit of the zero-torque determination reference power range.

4. The method of claim 1, wherein the zero-torque determination reference power range is determined according to the revolutions per minute of the driving motor and a torque in a torque range having a predetermined margin from zero-torque.

5. The method of claim 1, before the step of comparing, further comprising:
detecting, by a speed detector, the revolutions per minute of the driving motor.

6. The method of claim 1, before the step of calculating, further comprising:
detecting, by a current detector, the motor driving current thereby to send to a motor controller (MC).

7. The method of claim 1, wherein the step of comparing the revolutions per minute is performed by a motor controller (MC).

8. The method of claim 1, further comprising:
transmitting the q-axis current instruction to a current controller; and
comparing, by the current controller, the q-axis current instruction and a q-axis detection current to generate a q-axis voltage instruction.

9. The method of claim 8, further comprising:
performing, by a motor controller (MC), an axis transformation from a voltage instruction of a synchronous frame to a voltage instruction of a stationary frame.

10. The method of claim 8, further comprising:
supplying, by an inverter, a three-phase alternating current power as a driving power of the driving motor.
